(19) United States
(12) Patent Application Publication
(10) Pub. No.: US 2026/0029425 A1
(43) Pub. Date: Jan. 29, 2026

(54) MANIPULATOR, DETECTION DEVICE AND METHOD FOR DETECTING PHYSICAL FEATURE OF MICRO-NANO COMPONENT

(71) Applicant: MESOSCOPE TECHNOLOGY CO., LTD., HSINCHU CITY (TW)

(72) Inventor: HSIN-HAU HUANG, HSINCHU CITY (TW)

(21) Appl. No.: 19/219,746

(22) Filed: May 27, 2025

(30) Foreign Application Priority Data
Jul. 23, 2024 (TW) 113127519
Nov. 29, 2024 (CN) 202411738408.9

(51) Int. Cl. G01Q 10/02

(52) U.S. Cl. CPC G01Q 10/02

(57) ABSTRACT

The present disclosure relates to a manipulator used for clamping probes, a detection device having a manipulator, and a method for detecting the physical features of micro-nano components. The manipulator comprises a positioning adjustment assembly, which comprises a slide rail assembly. The slide rail assembly comprises a slide rail cover and an elastic element. The slide rail cover comprises a slide rail received in a slide groove of a slide rail base, and the two ends of the elastic element respectively fixed to the slide rail base and the slide rail cover. The manipulator further includes a handwheel assembly, a cantilever connected to the positioning adjustment assembly, and a clamping member comprising a hole. The handwheel assembly can contact the slide rail cover, and a connecting member is received within a groove of the cantilever.

The present application claims priority to and the benefit of China Application No. 202411738408.9 filed on Nov. 29, 2024 and Taiwan Application No. 113127519 filed on Jul. 23, 2024. The entirety of the above-mentioned patent applications is hereby incorporated by reference herein and made a part of specification.

### BACKGROUND

### 1. Field of the Disclosure

The present disclosure relates to a manipulator and a detection device, in particular, a detection device having a manipulator and a method for detecting the physical feature of micro-nano component using the same.

### 2. Description of Related Art

Probes are commonly used in the manufacturing and analysis processes of semiconductor components, particularly for detecting structures, dimensions, material properties, or potential defects in items such as chips, wafers, transistors, integrated circuits, or other micro-nano-scale electronic components. Different technical fields may have varying detection requirements, such as structural analysis or electrical testing. For example, an electron beam can be used to scan the surface of the object back and forth. By observing the reflected or transmitted light, the surface features (e.g., the shape of undulations) of the object can be detected, thereby detecting surface features of the object. As technology advances, the application of semiconductors is expanding, leading to a growing demand for semiconductor components. Additionally, the precise control required in semiconductor manufacturing makes probes particularly important in the industry.

In conventional detection technology, probes have a fixed length once installed in the detection device. However, objects to be tested vary in height and thickness, and the specific point on the object's surface that the probe tip needs to contact can differ. Therefore, the probe's length directly affects how far the tip penetrates into the object. If the probe is too short, it may not make adequate contact with the surface. Conversely, if the probe is too long, it may penetrate too deeply, potentially causing damage to both the probe and the object.

For the same reason, the adjustability of the detection device used to hold the probe is also important. Conventional detection devices for micro-nano components often encounter limitations due to the orientation of the rotation axis or the interconnections between components. These limitations hinder certain specific components, such as the component holding the probe and the cantilever of the manipulator, from moving relative to each other. Consequently, the detection device lacks sufficient adjustability. Given that the probe of a micro-nano component detection devices require precise coordinate adjustments and demands extreme precision, multi axial operability is essential for such devices. Moreover, if the probe cannot be securely clamped or accommodated within the detection device, it will significantly impact the accuracy of semiconductor processing or analysis procedures.

Therefore, we are seeking a solution to precisely adjust the distance between the probe and the object, and to enhance the adjustability of the detection device while maintaining the stability of the probe.

### SUMMARY

The present disclosure primarily provides a manipulator for clamping a probe, a detection device having the manipulator, and a method for detecting the physical feature of micro-nano component. The manipulator of the present disclosure offers multi-axial adjustment capabilities and excellent clamping stability. This enhances the flexibility and convenience of operating the detection device and improves the accuracy of measurement results.

An exemplary embodiment of the present disclosure provides a manipulator for clamping a probe, which comprises a positioning adjustment assembly arranged on a positioning adjustment base. The positioning adjustment assembly comprises a first slide rail assembly, which comprises a first slide rail cover and an elastic element. A slide rail of the first slide rail cover is received in a slide groove of the first slide rail base and is slidable relative to the slide groove. Two ends of the elastic element are attached to the first slide rail base and the first slide rail cover, respectively. Additionally, the manipulator comprises a handwheel assembly, a cantilever connected to the positioning adjustment assembly, and a clamping member comprising a hole. The handwheel assembly can be in contact with the slide rail cover. Furthermore, a connecting member is received within the groove of the cantilever.

An exemplary embodiment of the present disclosure provides a detection device for detecting a physical feature of a micro-nano component. The detection device comprises a manipulator of the present disclosure, a probe holder accommodated within the hole of the clamping member, and a probe that engages one end of the probe holder.

An embodiment of the present disclosure provides a method for detecting a physical feature of a micro-nano component. The method comprises arranging a detection device of the present disclosure on a base surface; providing a light source to irradiate the surface of the micro-nano component, so as to obtain an optical signal; and receiving and processing the optical signal to obtain information related to the physical feature of the micro-nano component.

### BRIEF DESCRIPTION OF THE DRAWINGS

Aspects of some embodiments of the present disclosure are readily understood from the following detailed description when read with the accompanying figures. It should be noted that various structures may not be drawn to scale, and dimensions of the various structures may be arbitrarily increased or reduced for clarity of discussion.

FIG. 1 is a schematic view showing a manipulator in accordance with one embodiment of the present disclosure.

FIG. 2A is the first perspective exploded view of the manipulator in accordance with above embodiment of the present disclosure.

FIG. 2B is a side view of the manipulator in accordance with above embodiment of the present disclosure, wherein a slide rail cover is in a neutral position.

FIG. 2C is a side view of the manipulator in accordance with above embodiment of the present disclosure, wherein a slide rail cover contacts a handwheel assembly and moves downward.

FIG. 2D is a side view of the manipulator in accordance with above embodiment of the present disclosure, wherein a slide rail cover contacts a handwheel assembly and moves upward.

FIG. 3A is the second perspective exploded view of the manipulator in accordance with above embodiment of the present disclosure.

FIG. 3B is a side view of the manipulator in accordance with above embodiment of the present disclosure, wherein a slide rail cover is in a neutral position.

FIG. 3C is a side view of the manipulator in accordance with above embodiment of the present disclosure, wherein a slide rail cover contacts a handwheel assembly and moves to the right.

FIG. 3D is a side view of the manipulator in accordance with above embodiment of the present disclosure, wherein a slide rail cover contacts a handwheel assembly and moves to the left.

FIG. 4A is the third perspective exploded view of the manipulator in accordance with above embodiment of the present disclosure.

FIG. 4B is a side view of the manipulator in accordance with above embodiment of the present disclosure, wherein a slide rail cover is in a neutral position.

FIG. 4C is a side view of the manipulator in accordance with above embodiment of the present disclosure, wherein a slide rail cover contacts a handwheel assembly and moves to the right.

FIG. 4D is a side view of the manipulator in accordance with above embodiment of the present disclosure, wherein a slide rail cover contacts a handwheel assembly and moves to the left.

FIG. 5A is a side view of the manipulator in accordance with above embodiment of the present disclosure, wherein a connecting member is accommodated within a groove of a cantilever.

FIG. 5B is a side view of the manipulator in accordance with above embodiment of the present disclosure, wherein a connecting member rotates counterclockwise about its one end.

FIG. 6A is a partially enlarged view of the manipulator in accordance with above embodiment of the present disclosure, wherein a clamping member is in a neutral position.

FIG. 6B is a partially enlarged view of the manipulator in accordance with above embodiment of the present disclosure, wherein a clamping member rotates clockwise.

FIG. 6C is a partially enlarged view of the manipulator in accordance with above embodiment of the present disclosure, wherein a first positioning plate and a second positioning plate are separated.

FIG. 7 is a schematic view showing a detection device having the manipulator in accordance with the above embodiment of the present disclosure.

FIG. 8 is a schematic view showing the detection device in accordance with the above embodiment of the present disclosure during a detection process.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It should be understood that, although the terms first, second, etc., may be used herein to describe various elements, these elements should not be limited by these terms. Unless indicated otherwise, these terms are only used to distinguish one element from another element.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to 12%, less than or equal to ±1%, less than or equal to ±±0.5%, less than or equal to ±0.1%, or less than or equal to ±0.05% For example, two numerical values can be deemed to be “substantially” the same as or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As shown in the figures of the instant application, and in the following description of the embodiments, to facilitate explanation of the disclosure, xyz-coordinates will be used. The xyz-coordinates include an X-axis and a Y-axis and a Z-axis.

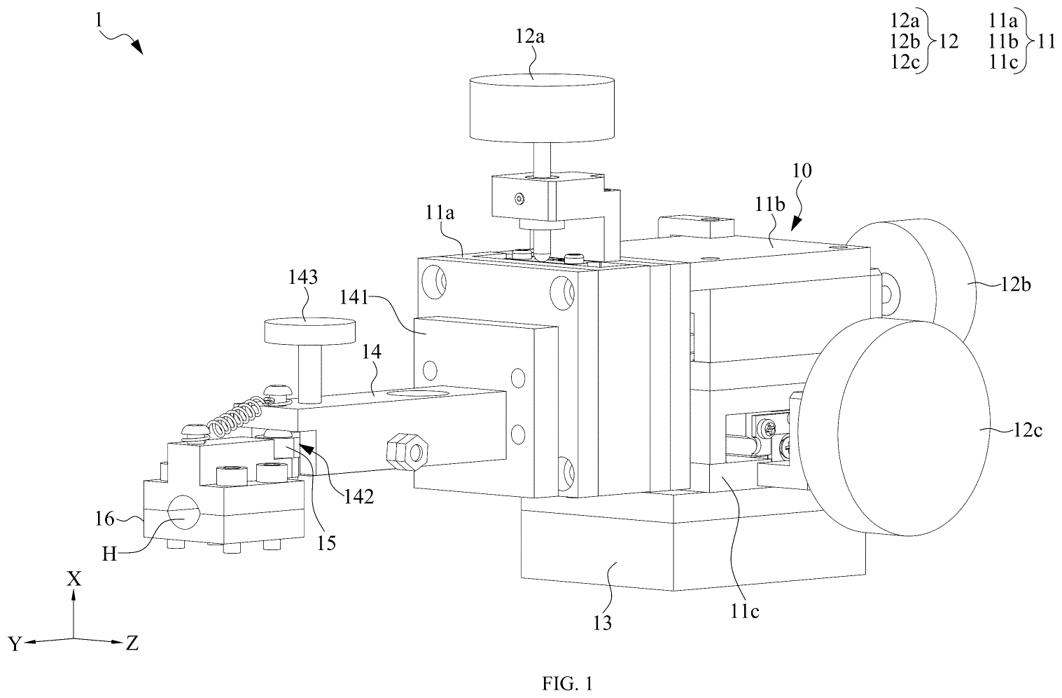

FIG. 1 is a schematic view showing a manipulator in one embodiment of the present disclosure. The manipulator 1 includes a positioning adjustment assembly 10, which comprises at least one slide rail assembly 11. Further, the positioning adjustment assembly 10 is connected to a positioning adjustment base 13. In some embodiments of the present disclosure, the slide rail assembly 11 may include a first slide rail assembly 11a, a second slide rail assembly 11b, and a third slide rail assembly 11c. In some embodiments of the present disclosure, the first handwheel assembly 12a may cooperate with the first slide rail assembly 11a to enable the cantilever 14 to move along the X-axis direction. Similarly, the second handwheel assembly 12b may cooperate with the second slide rail assembly 11b to enable the cantilever 14 to move along the Y-axis direction, and the third handwheel assembly 12c may cooperate with the third slide rail assembly 11c to enable the cantilever 14 to move along the Z-axis direction.

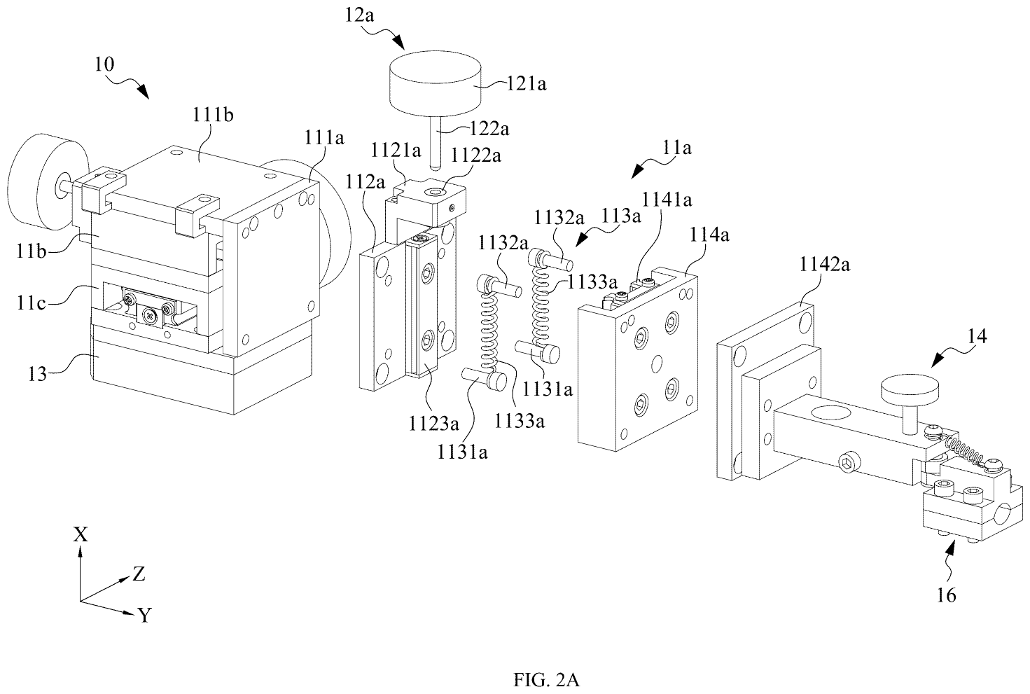

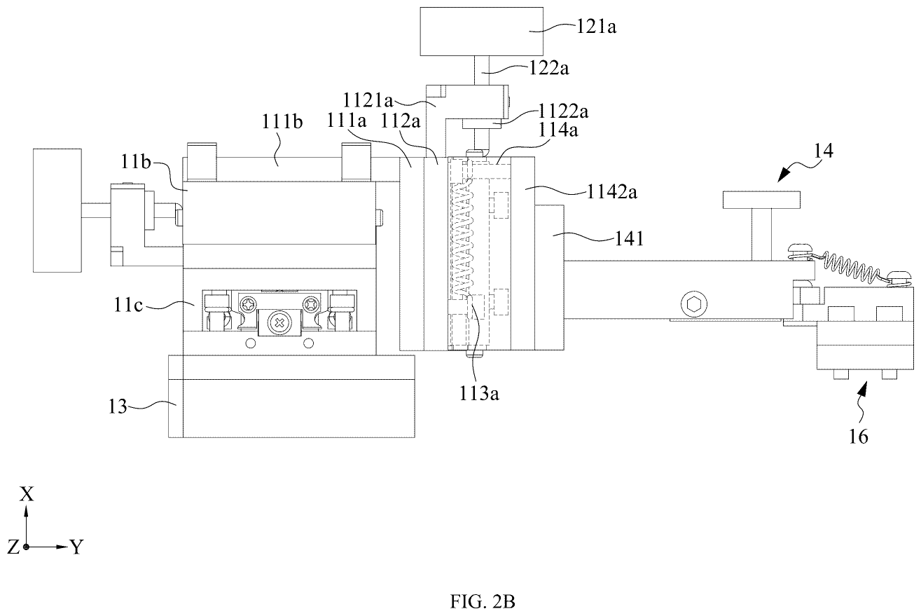

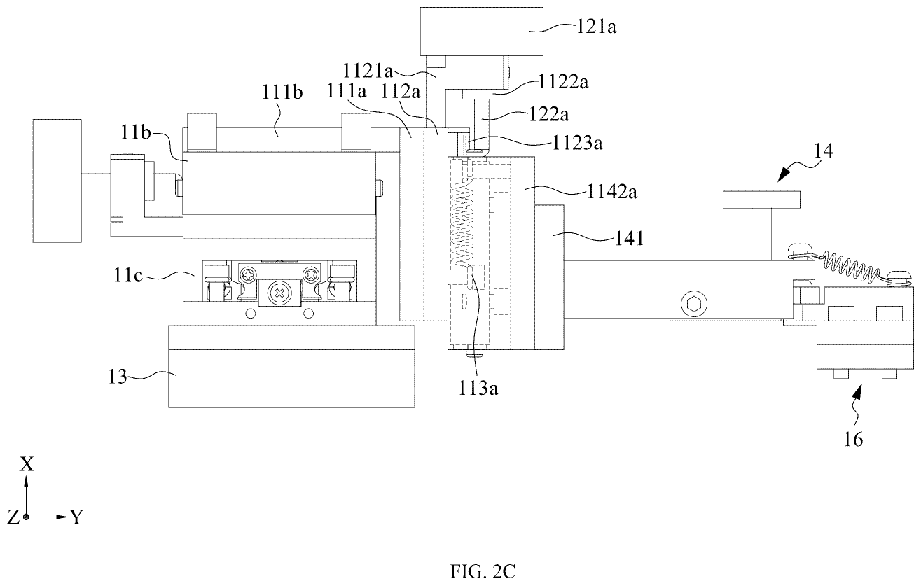

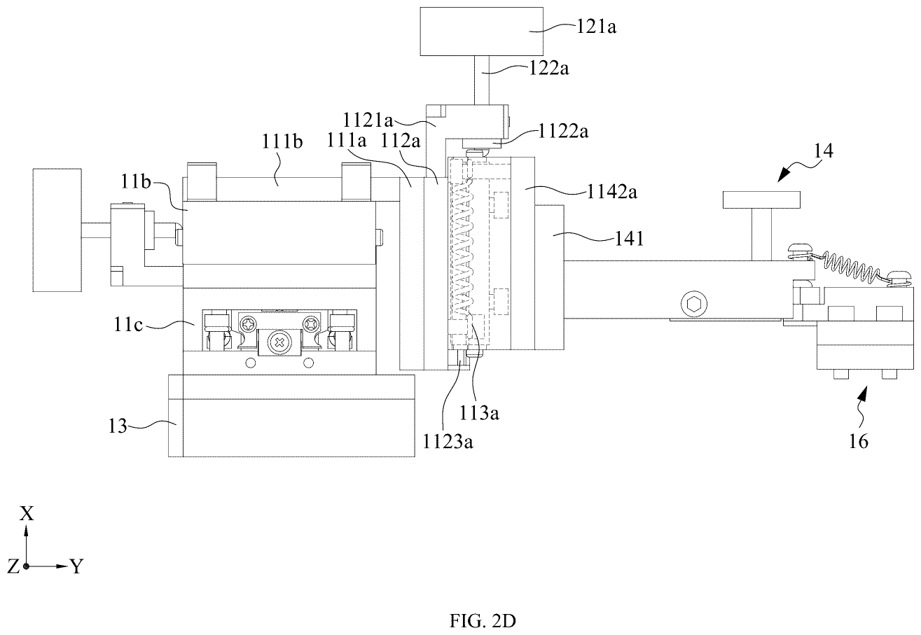

In some embodiments, the position of the handwheel assembly 12 can be configured differently according to the user's preference. For example, the third handwheel assembly 12c shown in FIG. 1 is positioned on the left side of the positioning adjustment assembly 10, while it can also be positioned on the right side of the positioning adjustment assembly 10 if needed (for example, if the user's dominant hand is different). Additionally, the knob portion of the handwheel assembly 12 (for example, the knob portion 121a of the first handwheel assembly 12a shown in FIG. 2A) may be threaded (not shown) to facilitate the user's rotational operation.

One end of the cantilever 14 may be connected to the positioning adjustment assembly 10 through the cantilever connecting plate 141. As shown in FIG. 1, the cantilever connecting plate 141 may comprise multiple holes, allowing it to be secured to the positioning adjustment assembly 10 using fasteners such as screws. In this manner, the cantilever 14 can be detachably mounted on one side of the positioning adjustment assembly 10 through the cantilever connecting plate 141, enabling users to quickly replace the cantilever 14 of the manipulator 1. In some embodiments, the cantilever 14 may also be integrally formed with the cantilever connecting plate 141. In other embodiments, multiple cantilevers 14 can be arranged on the surface of the cantilever connecting plate 141, with these cantilevers 14 being set at different positions and having the same or different lengths. Thus, multiple cantilevers 14 can be equipped with one or more clamping members 16, respectively.

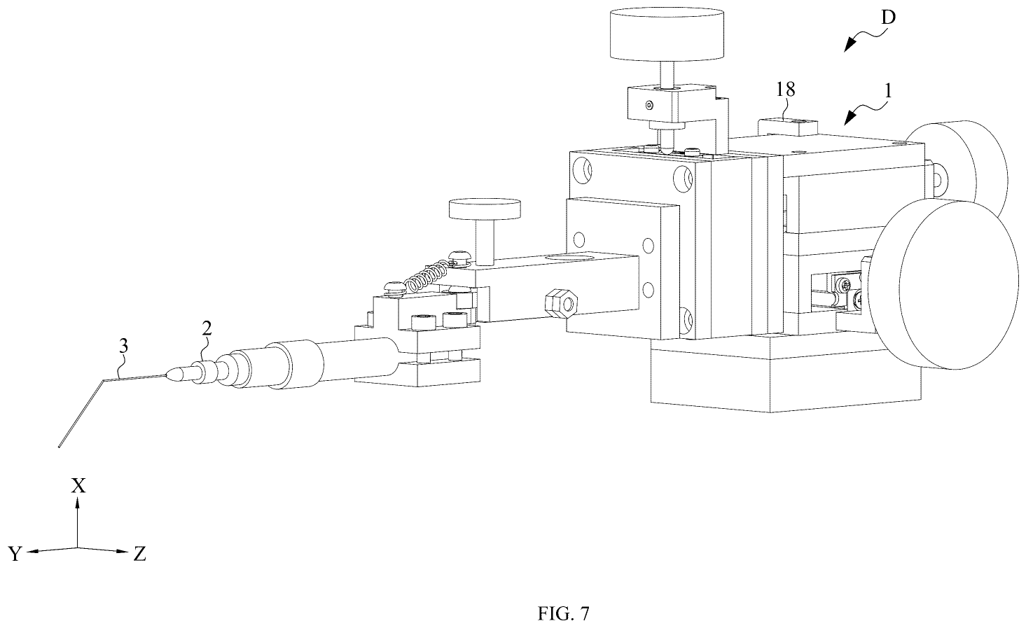

The cantilever 14 comprises a groove 142 configured to accommodate a connecting member 15. One end of the connecting member 15 may be pivotally connected to the inner wall of the groove 142, and the other end thereof may be configured to connect with a clamping member 16. The clamping member 16 may comprise a hole H configured to accommodate a probe holder 2 or other components. The probe holder 2 can hold various tools such as a probe 3 (see FIG. 7). In some embodiments, certain areas on the inner diameter surface of the hole H may comprise magnetic materials or profile limiting materials to stabilize the components accommodated within the hole H. Thus, the user can adjust the position of the probe 3 by operating the manipulator 1 to detect the physical features of the object to be tested (such as micro-nano components). In addition, the projected area of the holder 2 can be located within the cantilever 14. In other embodiments, the clamping members 16 can be multiple and located outside the projected area of the cantilever 14. These clamping members 16 may be used to hold at least one probe 3, a probe array, at least one probe card, or combinations thereof.

The following describes how the manipulator 1 of this disclosure achieves movement of the cantilever 14 along the X, Y, and Z axes using each handwheel assembly 12 and the corresponding slide rail assembly 11.

FIG. 2A illustrates a perspective exploded view of the manipulator in accordance with the embodiment of the present disclosure. The first slide rail connecting plate 111a of the first slide rail assembly 11a is connected to the second slide rail connecting plate 111b of the second slide rail assembly 11b, and the first slide rail base 112a is secured onto the first slide rail connecting plate 111a. Thus, an integral connection of the first slide rail base 112a with the second slide rail assembly 11b, the third slide rail assembly 11c, and the positioning adjustment base 13 is formed. Further, a first handwheel bracket 1121a may be arranged on the first slide rail base 112a, and a first guiding member 1122a may be positioned within the first handwheel bracket 1121a. The first handwheel bracket 1121a can be secured onto the first slide rail base 112a using fasteners such as screws. Alternatively, it can be integrally formed with the first slide rail base 112a. The shaft portion 122a of the first handwheel assembly 12a can pass through the through hole of the first guiding member 1122a to be engaged with the first handwheel bracket 1121a, which allows the shaft portion 122a to move relative to the first handwheel bracket 1121a through rotation.

Specifically, the shaft portion 122a of the first handwheel assembly 12a may be engraved with external threads (not shown), and the through hole in the first guiding member 1122a may be engraved with internal threads (not shown) corresponding to these external threads. When the user rotates the knob portion 121a of the first handwheel assembly 12a, the shaft portion 122a rotates accordingly, causing the external threads on the shaft portion 122a to engage with the internal threads of the through hole in the first guiding member 1122a. As such, the user can adjust the first handwheel assembly 12a by rotating, which allows the first handwheel assembly 12a to move relative to the first handwheel bracket 1121a of the first slide rail assembly 11a.

In some embodiments, the first slide rail assembly 11a may exclude the first handwheel bracket 1121a. In such a case, the first guiding member 1122a may be directly arranged on the surface of the first slide rail assembly 11a. Thus, the first handwheel assembly 12a may directly engage with the through hole of the first guiding member 1122a set on the surface of the first slide rail assembly 11a.

The first slide rail assembly 11a may further include at least one set of displacement adjustment assemblies 113a (two sets are shown in FIG. 2A) and a first slide rail cover 114a. Each displacement adjustment assembly 113a comprises a first fastener 1131a connected to the first slide rail base 112a, a second fastener 1132a connected to the first slide rail cover 114a, and a first elastic element 1133a arranged between the first fastener 1131a and the second fastener 1132a. As shown in FIG. 2A, one end of the first elastic element 1133a is attached to the first fastener 1131a and is thus fixed to the first slide rail base 112a. The other end of the first elastic element 1133a is attached to the second fastener 1132a and is thus fixed to the first slide rail cover 114a. The slide rail 1123a on the first slide rail base 112a may have an external contour that corresponds to the slide groove 1141a in the first slide rail cover 114a, allowing the slide rail 1123a to slide within the slide groove 1141a. In this manner, the first slide rail cover 114a can move relative to the first slide rail base 112a.

FIGS. 2A to 2D illustrate how the first slide rail assembly 11a cooperates with the first handwheel assembly 12a, wherein the first slide rail cover 114a shown in FIG. 2B is in a neutral position. The first handwheel assembly 12a passes through the through hole in the first handwheel bracket 1121a and is engaged with the first guiding member 1122a. The shaft portion 122a of the first handwheel assembly 12a may press against the surface of the first slide rail cover 114a. In some embodiments of the present disclosure, the shaft portion 122a may press against the surface of the slide groove 1141a. When the user operates the knob portion 121a of the first handwheel assembly 12a, the shaft portion 122a rotates and moves downward. As shown in FIG. 2B, one end of the first elastic element 1133a is fixed to both the first slide rail base 112a and the first slide rail connecting plate 111a using the first fastener 1131a, and these components are integrally connected to the second slide rail assembly 11b. The other end of the first elastic element 1133a is fixed to the first slide rail cover 114a using the second fastener 1132a. Thus, when the shaft portion 122a rotates, the end of the first elastic element 1133a that is fixed to the first slide rail base 112a remains stationary, while the other end, which is fixed to the first slide rail cover 114a, moves as the first elastic element 1133a compresses and extends. This causes the first slide rail cover 114a to move relative to the first slide rail base 112a

Referring to FIG. 2C, when the user rotates the knob portion 121a clockwise, the shaft portion 122a also rotates clockwise and presses downward along the Y-axis against the first slide rail cover 114a. In this way, the first elastic element 1133a may be compressed and deformed, causing the first slide rail cover 114a to move downward relative to the first slide rail base 112a. Conversely, as shown in FIG. 2D, if the user rotates the knob portion 121a counterclockwise, the shaft portion 122a rotates counterclockwise and moves upward. The restoring force generated by the deformation of the first elastic element 1133a then pushes the first slide rail cover 114a, keeping it in contact with the shaft portion 122a and driving it to move upward relative to the first slide rail base 112a.

As shown in FIG. 2A to FIG. 2D, the cantilever 14 is connected to the cantilever fixing plate 1142a through the cantilever connecting plate 141, which connects it to the first slide rail cover 114a of the first slide rail assembly 11a. Consequently, when the first slide rail cover 114a is moved up or down using the first handwheel assembly 12a, the cantilever 14 of the manipulator 1 also moves. This enables position adjustment of the cantilever 14 along the X-axis direction.

As described above, the user may adjust the position of the first slide rail cover 114a by operating the first handwheel assembly 12a. The maximum adjustable displacement through the first handwheel assembly 12a depends on the length of the shaft portion 122a. Specifically, when the end of the shaft portion 122a moves upward to become fully embedded in the through hole of the first guiding member 1122a, such as when the end of the shaft portion 122a is flush with the bottom surface of the guiding member, further rotation of the first handwheel assembly 12a to move the first slide rail cover 114a upward is not allowed. Similarly, when the bottom surface of the knob portion 121a contacts the top surface of the first handwheel bracket 1121a, further rotation of the first handwheel assembly 12a to move the first slide rail cover 114a downward is not allowed. In such a case, however, the user may still apply external force to further compress the first elastic element 1133a, thereby driving the first slide rail cover 114a and the cantilever 14 to continue moving downward. In some embodiment, by rotating the first handwheel assembly 12a, the first slide rail cover 114a can move approximately ±10 mm along the X-axis from a neutral position (as shown in FIG. 2B). That is, the first slide rail cover 114a can be moved upward or downward approximately 10 mm from the neutral position.

In some embodiments, the manipulator 1 may exclude either the cantilever connecting plate 141 or the cantilever fixing plate 1142a. In other words, one end of the cantilever 14 can be directly connected to the first slide rail cover 114a, or integrally formed with the first slide rail cover 114a, thereby achieving connection with the positioning adjustment assembly 10.

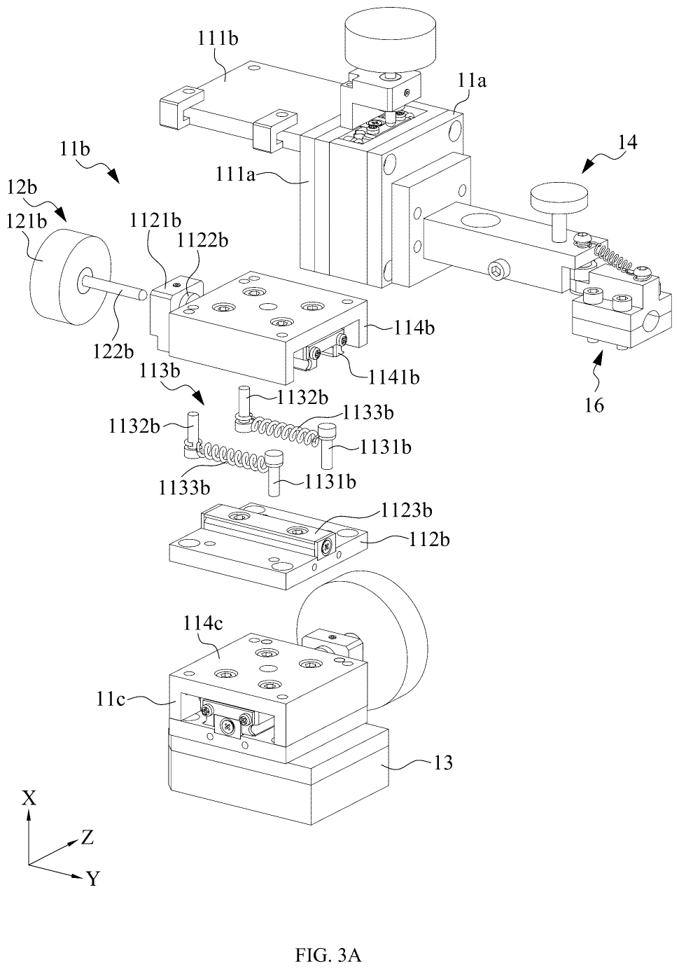

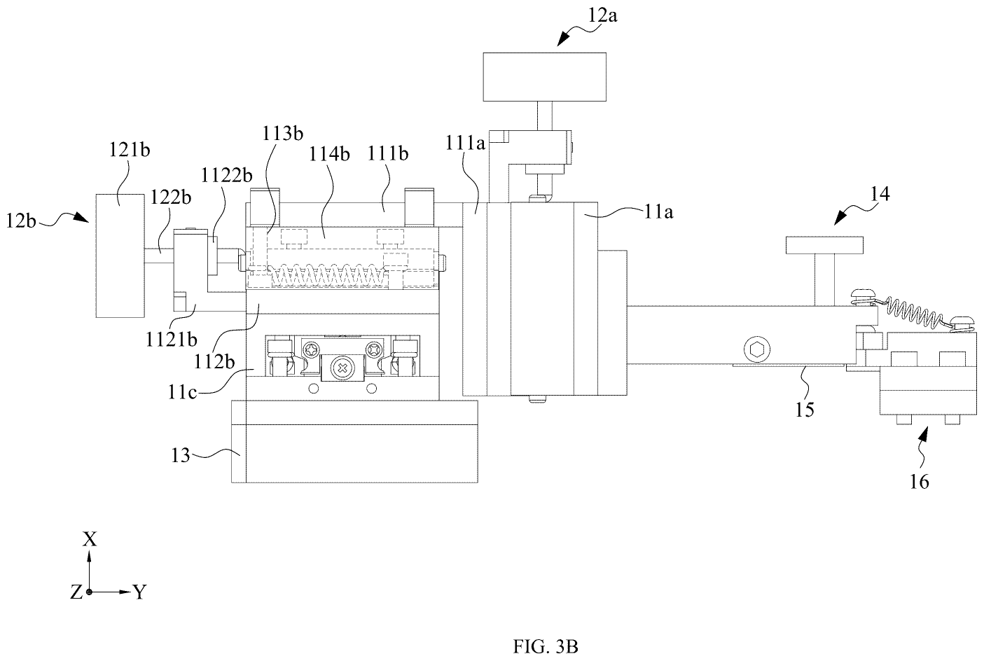

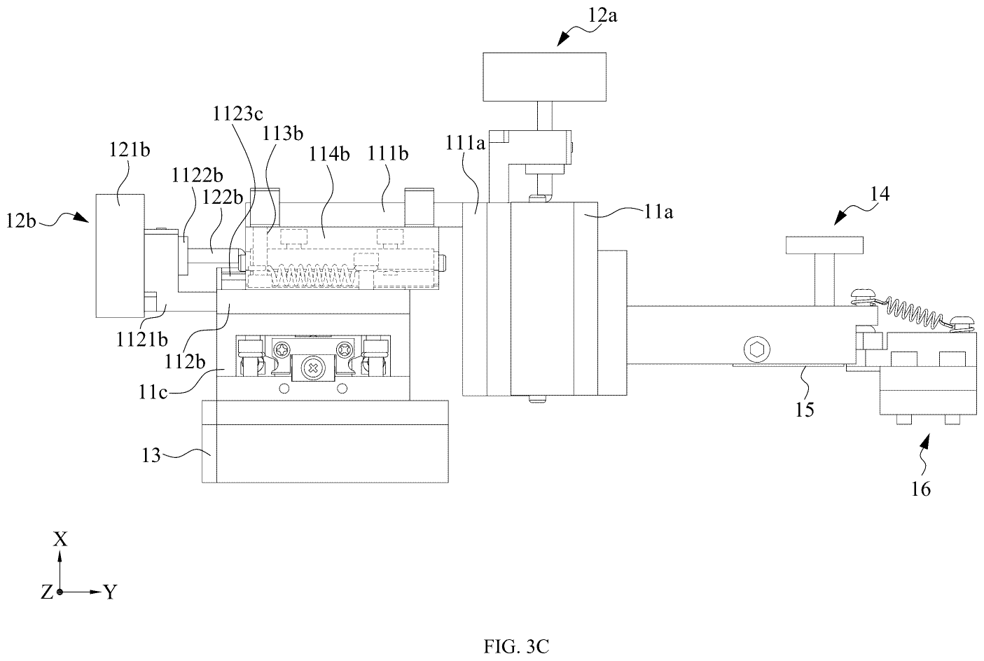

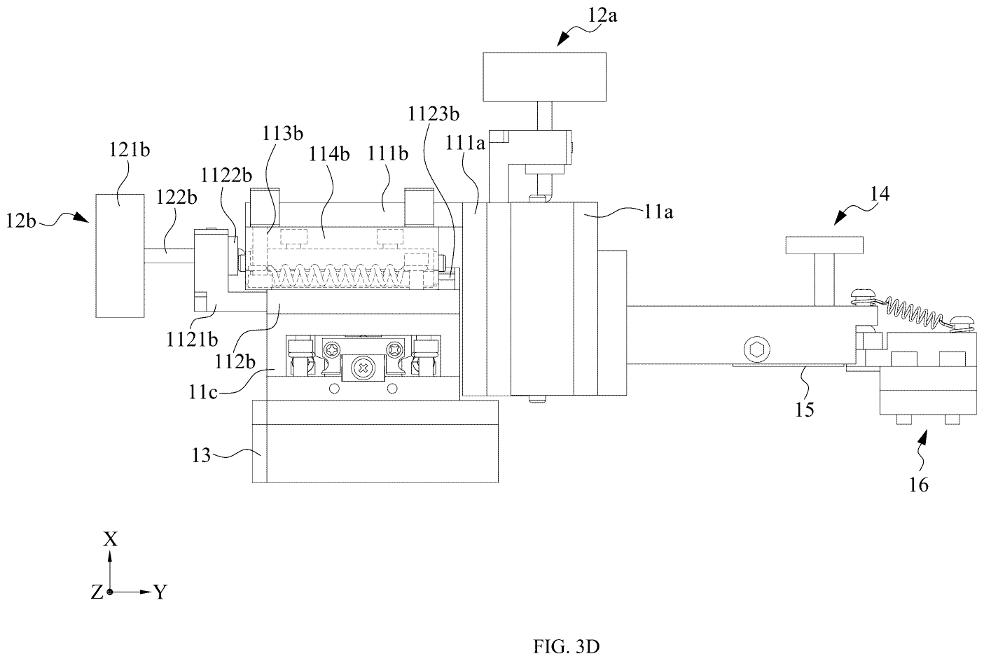

FIG. 3A illustrates the second perspective exploded view of the manipulator in accordance with the embodiment of the present disclosure. The second slide rail connecting plate 111b of the second slide rail assembly 11b is connected to the first slide rail connecting plate 111a of the first slide rail assembly 11a. The second slide rail cover 114b of the second slide rail assembly 11b is secured to the bottom surface of the second slide rail connecting plate 111b, and the second slide rail base 112b is secured to the third slide rail cover 114c of the third slide rail assembly 11c. Thus, the second slide rail assembly 11b is connected to the first slide rail assembly 11a, while its bottom surface also forms an integral connection with the third slide rail assembly 11c and the positioning adjustment base 13.

Similar to the first slide rail base 112a, a second handwheel bracket 1121b may be arranged on the second slide rail base 112b, and a second guiding member 1122b may be positioned within the second handwheel bracket 1121b. The second handwheel bracket 1121b can be secured onto the second slide rail base 112b using fasteners such as screws. Alternatively, it can be integrally formed with the second slide rail base 112b. As such, the shaft portion 122b of the second handwheel assembly 12b can pass through the through hole of the second guiding member 1122b to be engaged with the second handwheel bracket 1121b, which allows the shaft portion 122b to move relative to the second handwheel bracket 1121b through rotation. Additionally, the second slide rail assembly 11b may also include at least one set of displacement adjustment assemblies 113b. Each displacement adjustment assembly 113b comprises a third fastener 1131b connected to the second slide rail base 112b, a fourth fastener 1132b connected to the second slide rail cover 114b, and a second elastic element 1133b. One end of the second elastic element 1133b is attached to the third fastener 1131b and is thus fixed to the second slide rail base 112b. The other end of the second elastic element 1133b is attached to the fourth fastener 1132b and is thus fixed to the second slide rail cover 114b. Similarly, the slide rail 1123b on the second slide rail base 112b may have an external contour that corresponds to the slide groove 1141b in the second slide rail cover 114b, allowing the slide rail 1123b to slide within the slide groove 1141b. In this manner, the second slide rail cover 114b can move relative to the second slide rail base 112b.

In some embodiments, the second slide rail assembly 11b may exclude the second handwheel bracket 1121b. In such a case, the second guiding member 1122b may be directly arranged on the surface of the second slide rail assembly 11b. Thus, the second handwheel assembly 12b may directly engage with the through hole of the second guiding member 1122b set on the surface of the second slide rail assembly 11b.

FIGS. 3B to 3D illustrate how the second slide rail assembly 11b cooperates with the second handwheel assembly 12b, wherein the second slide rail cover 114b shown in FIG. 3B is in a neutral position. The second handwheel assembly 12b passes through the through hole in the second handwheel bracket 1121b and is engaged with the second guiding member 1122b. The shaft portion 122b of the second handwheel assembly 12b may press against the surface of the second slide rail cover 114b. In some embodiments of the present disclosure, the shaft portion 122b may press against the surface of the slide groove 1141b. When the user operates the knob portion 121b of the second handwheel assembly 12b, the shaft portion 122b rotates and moves to the right. As shown in FIG. 3A to FIG. 3B, one end of the second elastic element 1133b is fixed to both the second slide rail base 112b and the third slide rail cover 114c using the third fastener 1131b, and these components are integrally connected to the third slide rail assembly 11c and the positioning adjustment base 13. The other end of the second elastic element 1133b is fixed to the second slide rail cover 114b using the fourth fastener 1132b. Thus, when the shaft portion 122b rotates, the end of the second elastic element 1133b that is fixed to the second slide rail base 112b remains stationary, while the other end, which is fixed to the second slide rail cover 114b, moves as the second elastic element 1133b compresses and extends. This causes the second slide rail cover 114b to move relative to the second slide rail base 112b.

Referring to FIG. 3C, when the user rotates the knob portion 121b clockwise, the shaft portion 122b also rotates clockwise and presses toward the right along the Y-axis against the second slide rail cover 114b. In this way, the second elastic element 1133b may be compressed and deformed, causing the second slide rail cover 114b to move to the right relative to the second slide rail base 112b. Conversely, as shown in FIG. 3D, if the user rotates the knob portion 121b counterclockwise, the shaft portion 122b rotates counterclockwise and moves to the left. The restoring force generated by the deformation of the second elastic element 1133b then pushes the second slide rail cover 114b, keeping it in contact with the shaft portion 122b and driving it to move the left relative to the second slide rail base 112b.

As shown in FIG. 3A to FIG. 3D, the second slide rail connecting plate 111b of the second slide rail assembly 11b is interconnected with the first slide rail connecting plate 111a of the first slide rail assembly 11a, thereby allowing the integral connection between the first slide rail assembly 11a and the cantilever 14. Therefore, when the second slide rail cover 114b moves to the right or left using the second handwheel assembly 12b, the first slide rail assembly 11a and the cantilever 14 of the manipulator 1 moves accordingly. This achieves position adjustment of the cantilever 14 along the Y-axis direction. Additionally, similar to the first handwheel assembly 12a, the maximum displacement adjustable through the second handwheel assembly 12b depends on the length of the shaft portion 122b. In some embodiment, by rotating the second handwheel assembly 12b, the second slide rail cover 114b can move approximately ±10 mm along the Y-axis from the neutral position (as shown in FIG. 3B). That is, the second slide rail cover 114b can be moved approximately 10 mm to the right or left from the neutral position.

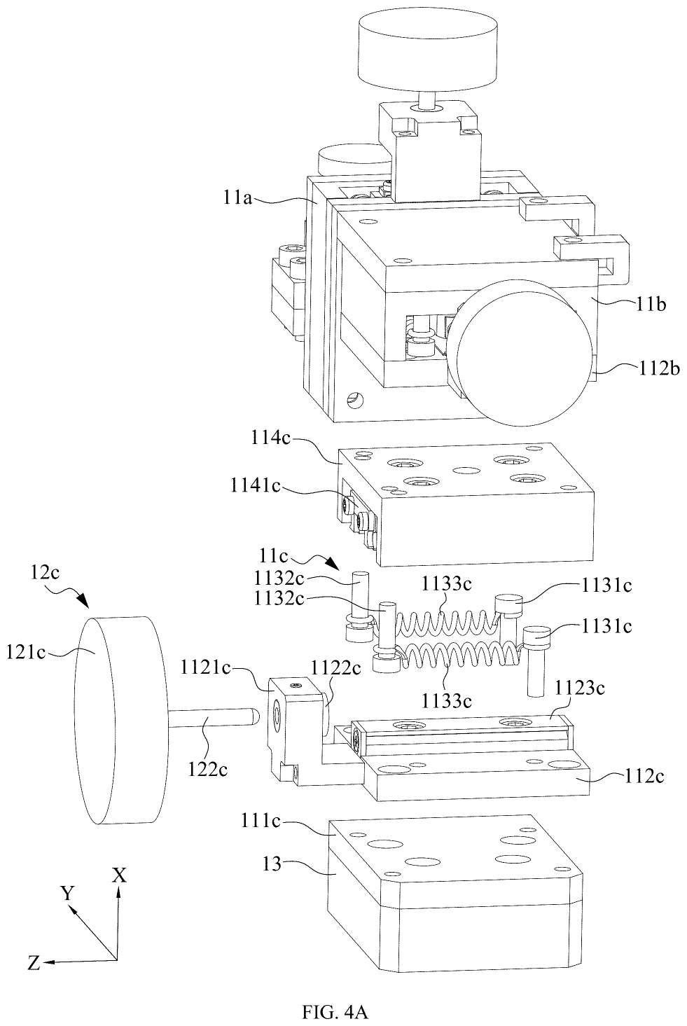

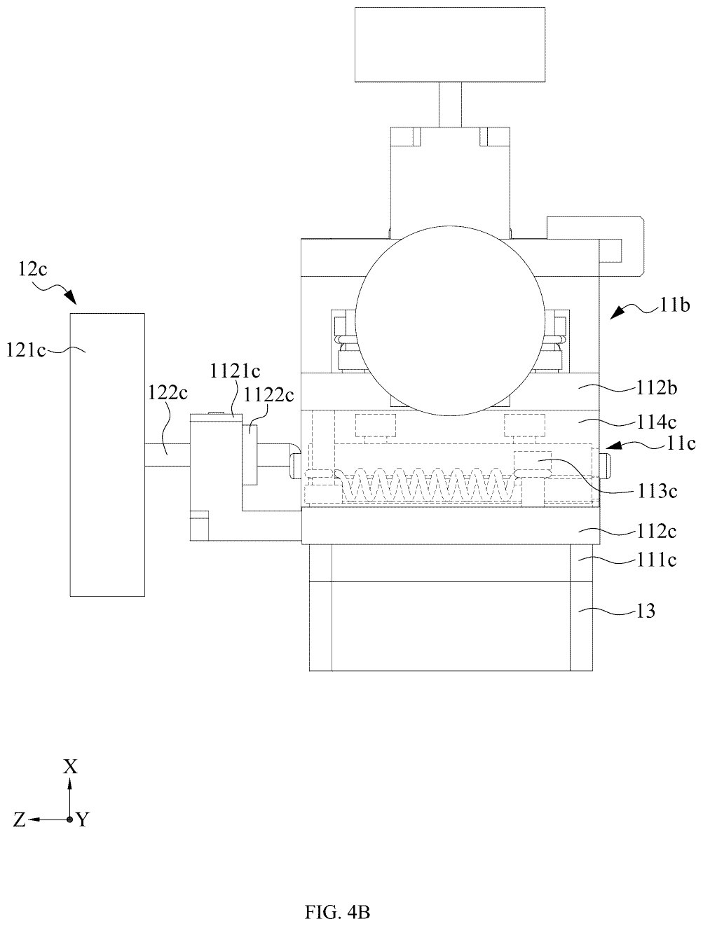

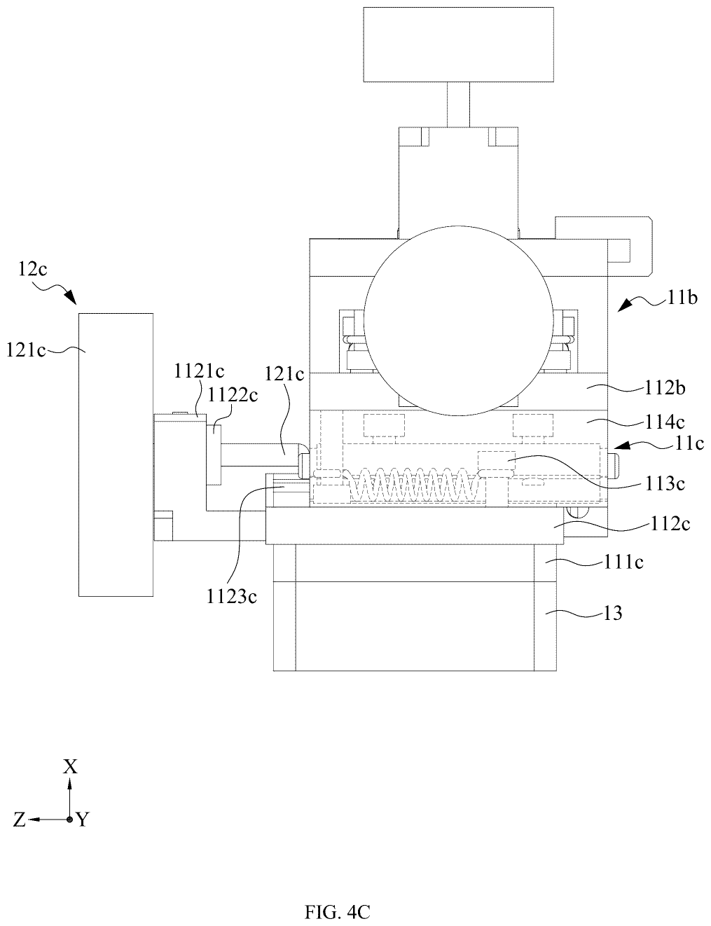

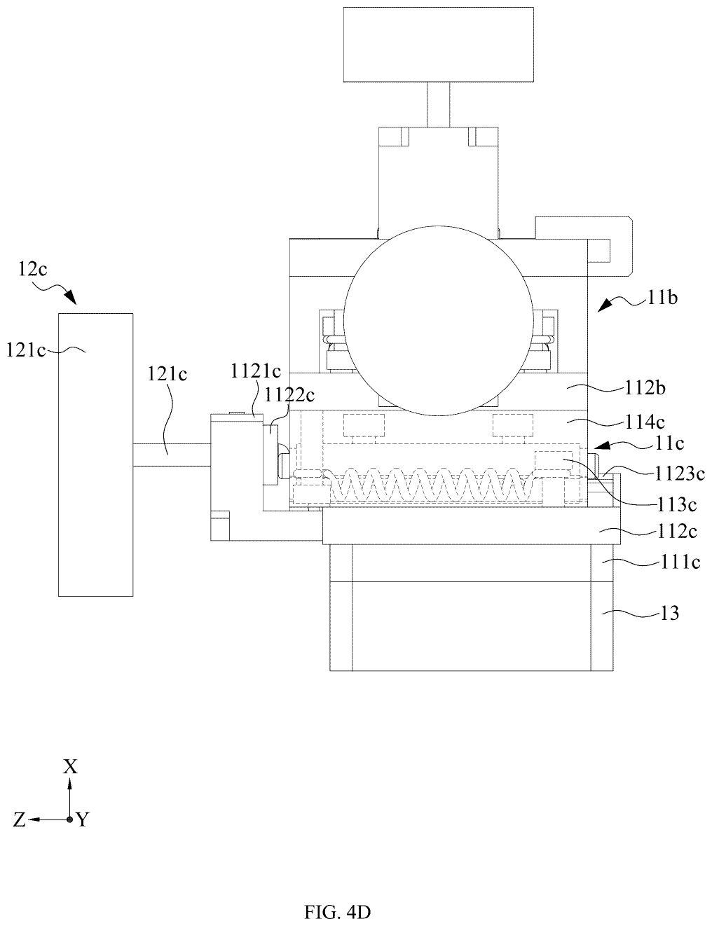

FIG. 4A illustrates the third perspective exploded view of the manipulator in accordance with the embodiment of this disclosure. The third slide rail cover 114c of the third slide rail assembly 11c is connected to the second slide rail base 112b of the second slide rail assembly 11b. The third slide rail base 112c of the third slide rail assembly 11c is mounted on the top surface of the third slide rail connecting plate 111c, and the third slide rail connecting plate 111c is mounted on the positioning adjustment base 13. Thus, the third slide rail assembly 11c is connected to the second slide rail assembly 11b while also being connected to the positioning adjustment base 13 through the third slide rail connecting plate 111c. In some embodiments, however, the third slide rail assembly 11c may exclude the third slide rail connecting plate 111c and instead connect directly to the positioning adjustment base 13 with the third slide rail base 112c.

Similar to the first slide rail assembly 11a and the second slide rail assembly 11b, a third handwheel bracket 1121c may be arranged on the third slide rail base 112c, and a third guiding member 1122c may be positioned within the third handwheel bracket 1121c. The third handwheel bracket 1121c can be secured onto the third slide rail base 112c using fasteners such as screws. Alternatively, it can be integrally formed with the third slide rail base 112c. As such, the shaft portion 122c of the third handwheel assembly 12c can pass through the through hole of the third guiding member 1122c to be engaged with the third handwheel bracket 1121c, which allows the shaft portion 122c to move relative to the third handwheel bracket 1121c through rotation. Additionally, the third slide rail assembly 11c may also include at least one set of displacement adjustment assemblies 113c. Each displacement adjustment assembly 113c comprises a fifth fastener 1131c connected to the third slide rail base 112c, a sixth fastener 1132c connected to the third slide rail cover 114c, and a third elastic element 1133c. One end of the third elastic element 1133c is attached to the fifth fastener 1131c and is thus fixed to the third slide rail base 112c. The other end of the third elastic element 1133c is attached to the sixth fastener 1132c and is thus fixed to the third slide rail cover 114c. Similarly, the slide rail 1123c on the third slide rail base 112c may have an external contour that corresponds to the slide groove 1141c in the third slide rail cover 114c, allowing the slide rail 1123c to slide within the slide groove 1141c. In this manner, the third slide rail cover 114c can move relative to the third slide rail base 112c.

In some embodiments, the third slide rail assembly 11c may exclude the third handwheel bracket 1121c. In such a case, the third guiding member 1122c may be directly arranged on the surface of the third slide rail assembly 11c. Thus, the third handwheel assembly 12c may directly engage with the through hole of the third guiding member 1122c set on the surface of the third slide rail assembly 11c.

FIGS. 4B to 4D illustrate how the third slide rail assembly 11c cooperates with the third handwheel assembly 12c, wherein the third slide rail cover 114c shown in FIG. 4B is in a neutral position. The third handwheel assembly 12c passes through the through hole in the third handwheel bracket 1121c and is engaged with the third guiding member 1122c. The shaft portion 122c of the third handwheel assembly 12c may press against the surface of the third slide rail cover 114c. In some embodiments of the present disclosure, the shaft portion 122c may press against the surface of the slide groove 1141c. When the user operates the knob portion 121c of the third handwheel assembly 12c, the shaft portion 122c rotates and moves to the right. As shown in FIG. 4A to FIG. 4B, one end of the third elastic element 1133c is fixed to both the third slide rail base 112c and the third slide rail connecting plate 111c using the fifth fastener 1131c, and these components are integrally connected to the positioning adjustment base 13. The other end of the third elastic element 1133c is fixed to both the third slide rail cover 114c and the second slide rail base 112b using the sixth fastener 1132c. Thus, when the shaft portion 122c rotates, the end of the third elastic element 1133c that is fixed to the third slide rail base 112c remains stationary, while the other end, which is fixed to the third slide rail cover 114c, moves as the third elastic element 1133c compresses and extends. This causes the third slide rail cover 114c to move relative to the third slide rail base 112c.

Referring to FIG. 4C, when the user rotates the knob portion 121c clockwise, the shaft portion 122c also rotates clockwise and presses toward the right along the Z-axis against the third slide rail cover 114c. In this way, the third elastic element 1133c may be compressed and deformed, causing the third slide rail cover 114c to move to the right relative to the third slide rail base 112c. Conversely, as shown in FIG. 4D, if the user rotates the knob portion 121c counterclockwise, the shaft portion 122c rotates counterclockwise and moves to the left. The restoring force generated by the deformation of the third elastic element 1133c then pushes the third slide rail cover 114c, keeping it in contact with the shaft portion 122c and driving it to move the left relative to the third slide rail base 112c.

As shown in FIG. 4A to FIG. 4D, the third slide rail cover 114c of the third slide rail assembly 11c is interconnected with the second slide rail base 112b of the second slide rail assembly 11b, thereby allowing the integral connection between the first slide rail assembly 11a, second slide rail assembly 11b, and the cantilever 14 (not shown). Therefore, when the third slide rail cover 114c moves to the right or left using the third handwheel assembly 12c, the cantilever 14 of the manipulator 1 moves accordingly. This achieves position adjustment of the cantilever 14 along the Z-axis direction. Additionally, similar to the first handwheel assembly 12a and the second handwheel assembly 12b, the maximum displacement adjustable through the third handwheel assembly 12c depends on the length of the shaft portion 122c. In some embodiment, by rotating the third handwheel assembly 12c, the third slide rail cover 114c can move approximately ±10 mm along the Z-axis from the neutral position (as shown in FIG. 4B). That is, the third slide rail cover 114c can be moved approximately 10 mm to the right or left from the neutral position.

The following describes the process of rotating the connecting member 15 of the manipulator 1 in the XZ plane by adjusting the height adjustment knob 143. This adjustment can change the position of the probe 3 tip along the X-axis direction (see FIG. 7).

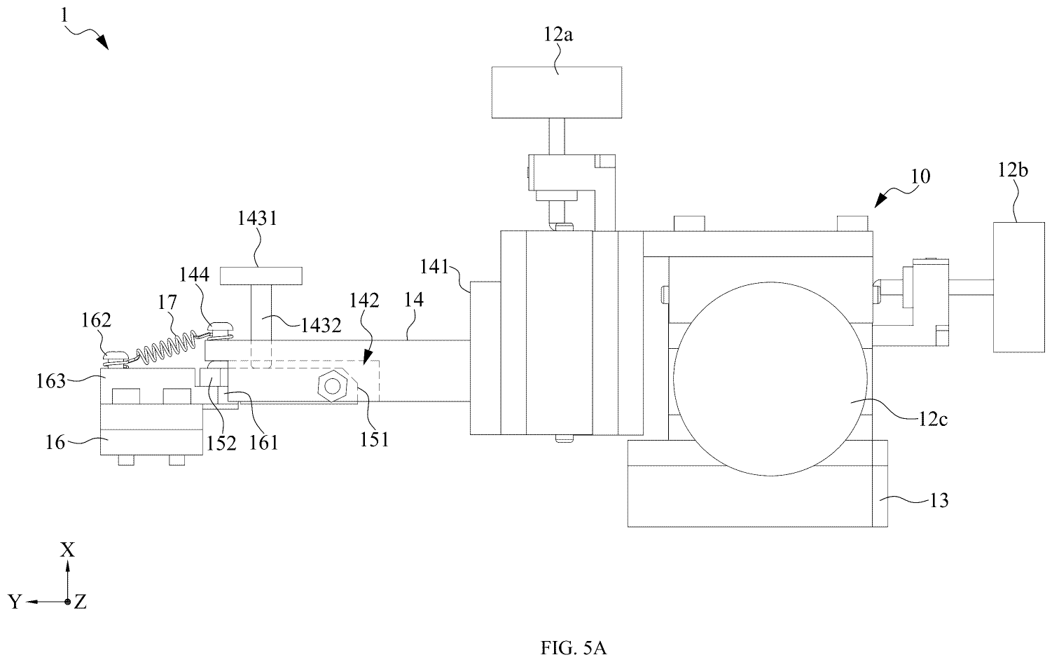

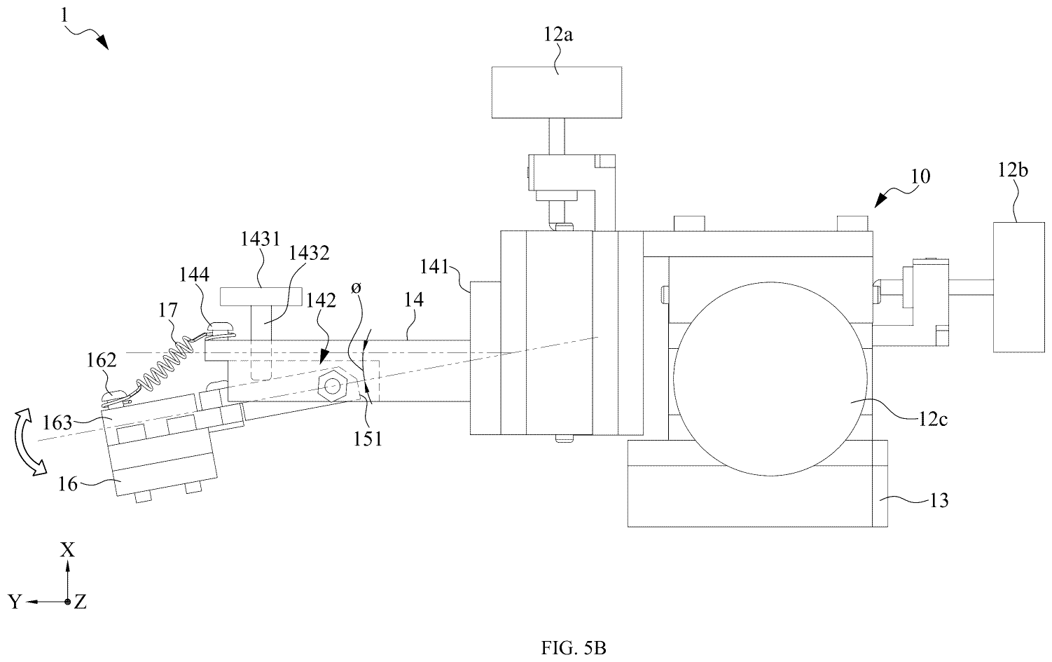

FIG. 5A shows the connecting member 15 accommodated within the groove 142 of the cantilever 14. FIG. 5B shows the connecting member 15 in a state of rotation about its first end 151 in a counterclockwise direction. As best seen in FIG. 5A, the cantilever 14 comprises a groove 142, which is configured to accommodate the connecting member 15. The first end 151 of the connecting member 15 is positioned within the groove 142 and is pivotally connected to the cantilever 14 using fasteners such as a bolt and nut.

The manipulator 1 further includes a clamping member 16. The first end 161 of the clamping member 16 has an external contour complementary to the second end 152 of the connecting member 15 and is connected to the second end 152 of the connecting member 15 using fasteners such as screws. Additionally, as shown in FIG. 1, the clamping member 16 has a hole H, which is configured to receive the probe holder 2 of the detection device D. The probe holder 2 may hold various probing tools such as the probe 3 (see FIG. 7). Thus, the user can adjust the position of the probe 3 by operating the clamping member 16 of the manipulator 1, thereby detecting the physical feature of the object to be tested (such as micro-nano components).

As shown in FIG. 5A and FIG. 5B, the cantilever 14 further includes a height adjustment knob 143, which is positioned adjacent to the second end 152 of the connecting member 15. Similar to the handwheel assembly 12, the height adjustment knob 143 includes a knob portion 1431 and a shaft portion 1432 with external threads (not shown). Additionally, the outer surface of the knob portion 1431 may be threaded (not shown) to facilitate user's operation. The cantilever 14 comprises a through hole (not shown) at the position corresponding to the shaft portion 1432, and the inner wall of this through hole has internal threads that correspond to the external threads of the shaft portion 1432. This allows the height adjustment knob 143 to be connected to the cantilever 14 through the shaft portion 1432, enabling it to rotate and engage with the cantilever 14.

The manipulator 1 further includes an elastic element 17, with its two ends respectively fixed to the cantilever 14 and the clamping member 16. Specifically, the cantilever 14 may include a first anchor member 144 mounted on the top surface near the end adjacent to the clamping member 16, while the clamping member 16 may include a second anchor member 162 mounted on the top surface on the side away from the cantilever 14. The two ends of the elastic element 17 can be fixed to the first anchor member 144 of the cantilever 14 and the second anchor member 162 of the clamping member 16, respectively. Additionally, the distance between the first anchor member 144 and the second anchor member 162 can be adjusted according to user's needs. For example, considering the elastic coefficient of the elastic element 17, the clamping member 16 may include a protrusion 163 on which the second anchor member 162 is positioned. Thus, the distance between the first anchor member 144 and the second anchor member 162 can be reduced.

In the configuration of the embodiment, the height adjustment knob 143 is located near the second end 152 of the connecting member 15, while the first end 151 is pivotally connected to the cantilever 14. Thus, when the user rotates the knob portion 1431 of the height adjustment knob 143 clockwise, the shaft portion 1432 may also rotate clockwise and move downward.

Subsequently, the end portion of the shaft portion 1432 presses against and pushes the connecting member 15. Moreover, since the first end 151 of the connecting member 15 is pivotally connected to the cantilever 14, the connecting member 15 is restricted from moving along the X-axis and Y-axis. Thus, as the shaft portion 1432 pushes the connecting member 15 downward, the connecting member 15 rotates on the XY plane about its first end 151 (more specifically, at the pivot position where it connects to the cantilever 14).

When the user rotates the knob portion 1431 clockwise, the shaft portion 1432 presses down against the connecting member 15, causing the second end 152 of the connecting member 15 to rotate downward. Meanwhile, the elastic element 17 is stretched and deformed, providing a restoring force (elastic force) between the cantilever 14 and the clamping member 16. Conversely, when the user rotates the knob portion 1431 of the height adjustment knob 143 counterclockwise, the shaft portion 1432 moves upward, and the restoring force (elastic force) generated by the deformation of the elastic element 17 causes the clamping member 16 to return to its initial position (as shown in FIG. 5A).

As shown in FIG. 5B, by rotating the height adjustment knob 143, the connecting member 15 can rotate about its first end 151 on the XY plane. Thus, the angle φ between the connecting member 15 and the Y-axis can be adjusted. The range of angle φ that can be adjusted by rotating the height adjustment knob 143 depends on the length of the shaft portion 1432. In some embodiments, the angle φ can range from approximately 0 to 10 degrees.

The second end 152 of the connecting member 15 basically rotates in the XY plane. Since the first end 161 of the clamping member 16 is connected to the second end 152 of the connecting member 15, the downward rotation of the second end 152 may cause the clamping member 16 to rotate as well. However, when the clamping member 16 holds the probe holder 2 and further secures the probe 3 (see FIG. 7), the slight displacement of the probe 3 tip in the Y-axis direction caused by the rotation of the clamping member 16 can be considered negligible. Therefore, when the probe 3 is held by the probe holder 2, and the probe holder 2 is clamped in the clamping member 16, the angle φ between the connecting member 15 and the Y-axis can be adjusted by rotating the height adjustment knob 143. This operation allows for minor adjustments to the position of the probe 3 tip along the X-axis.

With the configuration of the embodiment, the user may operate the height adjustment knob 143 and allows the connecting member 15 to rotate about its first end 151 on the XY plane, thereby adjusting the position of the clamping member 16 in the X-axis direction. This enhances the flexibility of the detection device D during operation and improves measurement accuracy. Additionally, the elastic element 17 provides cushioning and damping effects when the probe 3 contacts the object, enhancing the stability of the probe 3 and further improving the accuracy of the detection device D during detection.

The following describes how the manipulator 1 of the present disclosure adjusts the position of the probe 3 in the YZ plane by adjusting the angle between the clamping member 16 and the connecting member 15.

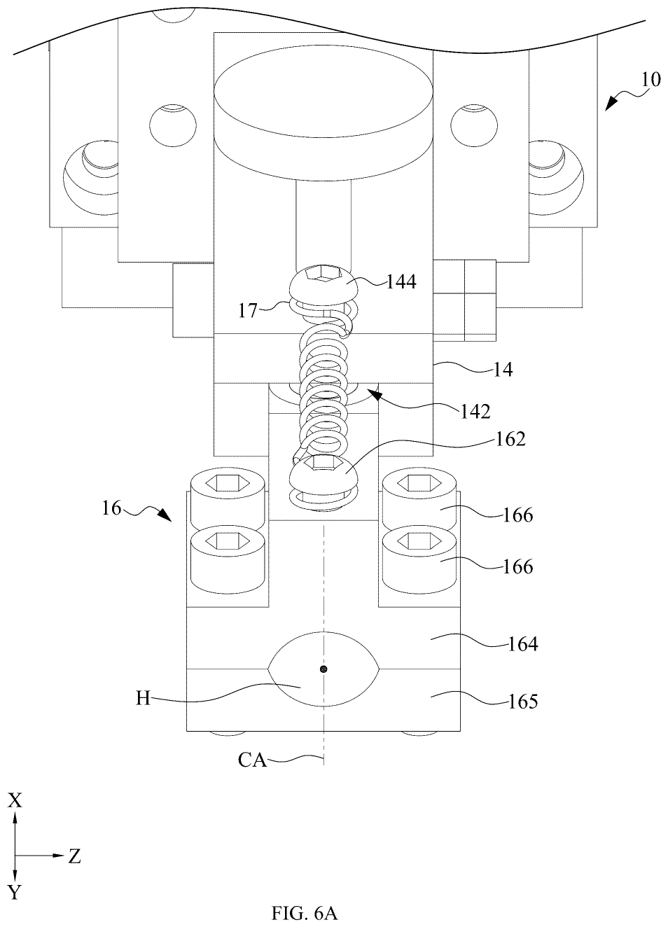

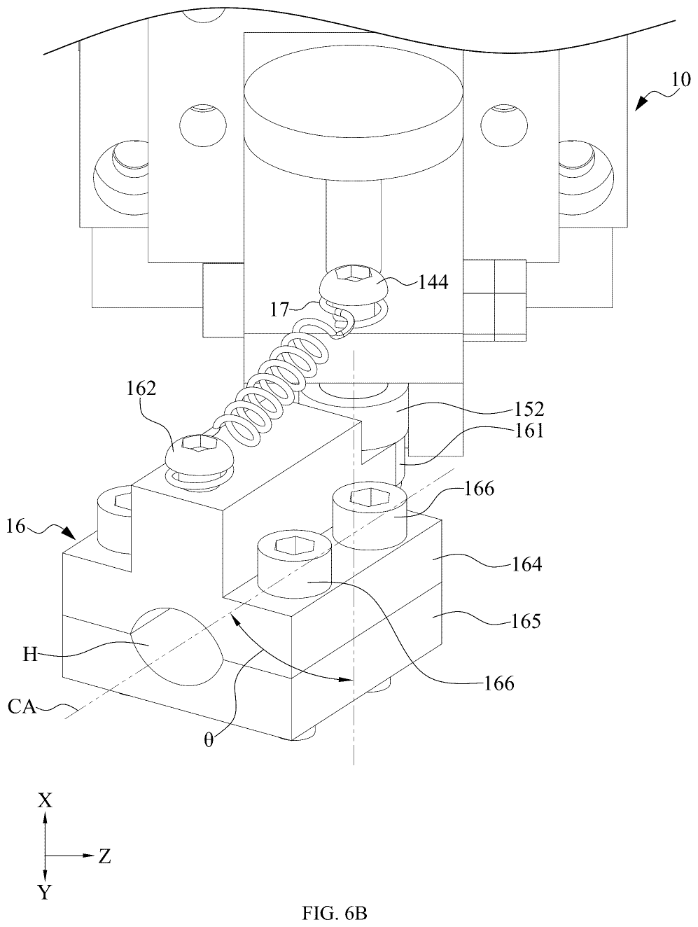

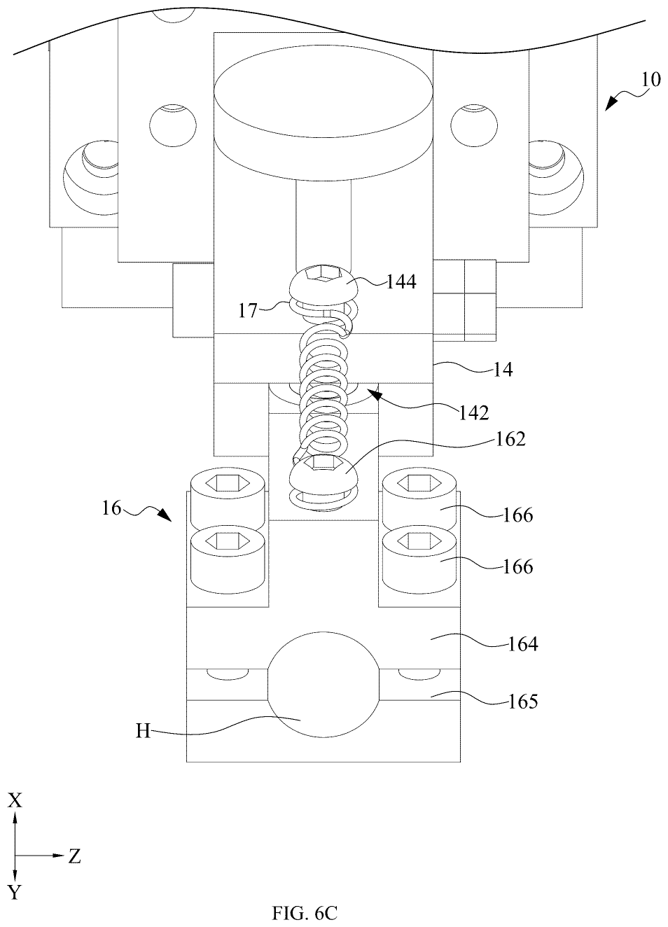

FIG. 6A illustrates the clamping member 16 in a neutral position. FIG. 6B shows the clamping member 16 in a state of clockwise rotation on the YZ plane. Referring to FIG. 5A to FIG. 6B, the first end 161 of the clamping member 16 is pivotally connected to the second end 152 of the connecting member 15 using fasteners such as a bolt and nut, allowing the clamping member 16 to rotate relative to the second end 152 of the connecting member 15. When clamping member 16 is rotated (as shown in FIG. 6B), the angle θ between the central axis CA of the hole H of the clamping member 16 and the connecting member 15 can be adjusted. The angle θ between the central axis CA and the connecting member 15 can range from about 0 degrees to ±30 degrees. In some embodiments, the angle θ can range from about 0 degrees to ±70 degrees. That is, the clamping member 16 can rotate to the left or right relative to the second end 152 of the connecting member 15, forming an angle θ between the central axis CA and the connecting member 15. This angle θ can range from approximately 0 degrees to 70 degrees.

Since the probe 3 can be held the manipulator 1 through the probe holder 2 and the clamping member 16, the configuration of the above embodiment allows for the adjustment of the position of the probe 3 in the YZ plane by rotating the clamping member 16. This enhances the flexibility of the detection device D during the detection process.

FIG. 6C illustrates a separated state of the first positioning plate 164 and the second positioning plate 165. Referring to FIG. 6A and FIG. 6C, the clamping member 16 may include a first positioning plate 164 and a second positioning plate 165. In the embodiment shown in the figures, the first positioning plate 164 and the second positioning plate 165 are respectively located on the upper and lower sides.

The hole H of the clamping member 16 can be formed between the first positioning plate 164 and the second positioning plate 165. Specifically, each of the first positioning plate 164 and the second positioning plate 165 comprises a substantially arch-shaped semi-hole that corresponds to each other. These semi-holes also correspond to the upper and lower contours of the probe holder 2, respectively. When the first positioning plate 164 and the second positioning plate 165 are brought close to each other, these two arch-shaped semi-holes form a complete hole H that can accommodate the probe holder 2.

One or more distance adjustment elements 166 may be further disposed between the first positioning plate 164 and the second positioning plate 165. These distance adjustment elements 166 are used to adjust the distance between the first positioning plate 164 and the second positioning plate 165, thereby further adjusting the size of the hole H. As shown in FIG. 6A to FIG. 6C, in some embodiments, the distance adjustment element 166 may comprise fasteners such as bolts and nuts. When the probe holder 2 is installed in the hole H, the user can rotate the distance adjustment element 166 to adjust the distance between the first positioning plate 164 and the second positioning plate 165, thereby tightening or loosening the clamping of the probe holder 2.

In other embodiments, the distance adjustment element 166 may alternatively comprise components such as elastic elements. In such a case, when the user pulls the second positioning plate 165 to separate it from the first positioning plate 164, the distance adjustment element 166 may deform and provide a restoring force (elastic force) between the first positioning plate 164 and the second positioning plate 165, thereby pulling the second positioning plate 165 back to its initial position (as shown in FIG. 6A). As such, the probe holder 2 can be securely clamped within the hole H.

Additionally, it is appreciated that when the external contour of the probe holder 2 is exactly equal to or smaller than the size of the hole H, the clamping member 16 can secure the probe holder 2 therein, wherein the first positioning plate 164 and the second positioning plate 165 are in contact with each other. However, when the external contour dimensions of the probe holder 2 exceed the size of the hole H, the clamping member 16 can still secure the probe holder 2 therein, wherein the first positioning plate 164 and the second positioning plate 165 are not in contact with each other. In such a case, at least a portion of the external contour of the probe holder 2 contacts the peripheral wall of the hole H.

The above configuration allows the user to replace the probe holder 2 with different sizes according to their needs. Moreover, the probe holder 2 can be securely clamped by the clamping member 16, thereby enhancing the stability of the detection device D during the detection process.

The above descriptions explain the operation of the manipulator 1 in the XY plane (as shown in FIG. 5A to FIG. 5B) and the operation of the manipulator 1 in the YZ plane (as shown in FIG. 6A to FIG. 6C) respectively. However, it is appreciated that adjustments in these different planes can be performed concurrently. For example, the connecting member 15 can rotate downward about its first end 151 (as shown in FIG. 5B) while the clamping member 16 rotates clockwise relative to the connecting member 15 (as shown in FIG. 6B).

FIG. 7 shows a detection device D having the manipulator 1 of the present disclosure. The detection device D may be used for detecting the physical feature of micro-nano component and comprises a manipulator 1, a probe holder 2, and a probe 3. The structure of the manipulator 1 and the connections between its components have been described above and will not be repeated here.

The hole H of the clamping member 16 of the manipulator 1 is configured to receive the probe holder 2 of the detection device D. One end of the probe holder 2 may hold and secure the probe 3 therein. In other embodiments, the probe holder 2 can be used to clamp other components such as optical path correction accessories, semiconductor testing consumables, integrated circuit testing consumables, rigid wires, cables, or electrodes. In practice, probe 3 may comprise a micro probe, nano probe, angstrom probe, or other probes used for detecting micro-nano scale components. Furthermore, the probe 3 can be a linear needle-like object or can be bent to have a curved section (as shown in FIG. 7). In some embodiments, at least one probe holder 2 is configured to be accommodated within the hole H of the clamping member 16 of the manipulator 1. One end of the probe holder 2 can engage multiple probe arrays arranged at intervals on a carrier probe card. In other embodiments, at least one probe 3 or probe card can be positioned within the clamping area of the hole H of the clamping member.

One end of the probe holder 2 is engaged with the probe 3, while the opposite end thereof can be electrically connected to a cable (not shown). The cable may comprise a conductive wire, communication wire, data transmission wire, or other wire with similar functions. Thus, electrical signals can be received and transmitted through the cable during the detection process.

As shown in FIG. 7, the manipulator 1 of the detection device D may further include a cable clip 18, which is arranged on the positioning adjustment assembly 10. In some embodiments, the cable clip 18 may be positioned on the top of the positioning adjustment assembly 10, specifically on the second slide rail connecting plate 111b, and secured by fasteners such as screws. The cable clip 18 is configured to allow cables pass through it. In other embodiments, the cable clip 18 may be positioned at any location on the manipulator 1, such as the midsection of the positioning adjustment assembly 10 or the positioning adjustment base 13. Additionally, the cable clip 18 may be integrally formed with the manipulator 1. Thus, cables (not shown) can be neatly housed within the cable clip 18, thereby preventing interference with the operation of the detection device D during the detection process.

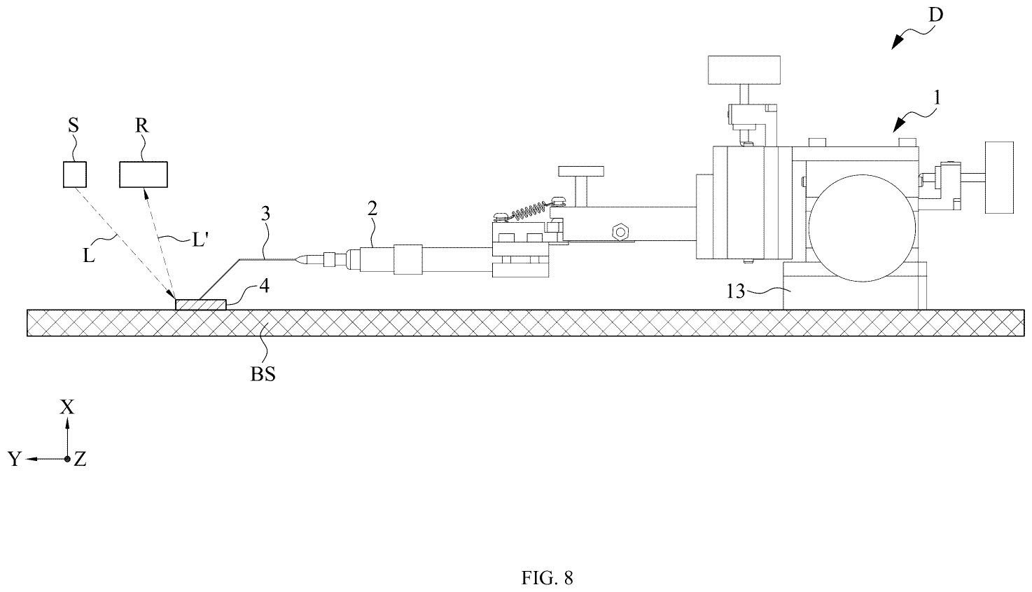

FIG. 8 shows the detection device D during the detection process. In practice, the detection device D can be placed on the base surface BS. The base surface BS may comprise a flat surface, a curved surface, an irregular non-flat surface, or a groove or protruding structure relative to the surrounding environment. Moreover, the base surface BS may comprise flexible materials, non-flexible materials, or a combination thereof. As shown in FIG. 8, the positioning adjustment base 13 contacts the base surface BS. The bottom surface of the positioning adjustment base 13 may comprise a flat surface, a curved surface, an irregular non-flat bottom surface, or a surface complementary to the contour of the base surface BS. In some embodiments, the positioning adjustment base 13 may be magnetic and capable of adhering to the base surface BS, thereby enhancing the stability of the detection device D during the detection process.

The present disclosure also provides a method for detecting the physical feature of micro-nano component. The method includes providing a detection device D having a manipulator 1 arranged on a base surface BS. The structure of the manipulator 1, detection device D, and the connections between theirs components have been described above and will not be repeated here.

During the detection process, the detection device may be arranged on the base surface BS. The object 4 may comprise a chip, wafer, transistor, integrated circuit, or other micro-nano scale electronic components. During the detection process, one or more visible or/and invisible light sources S can be provided. Also, one or more signal transceivers can be provided to collect information regarding the physical feature of the object 4.

Specifically, when the probe 3 approaches or contacts the surface of the object 4, the light source S can be operated to emit a light beam L, which irradiates the surface of the object 4 and generates a reflected light beam U. At this time, the receiver R in the transceiver can be configured to receive the reflected light beam L′, thereby obtaining optical signals related to the object 4. Subsequently, the receiver R can transmit the received optical signals to an electronic device (such as a mobile terminal, tablet, desktop computer, or any other electronic device capable of data processing) through the transmitter of the transceiver for computational processing, thereby obtaining information related to the physical features of the object 4.

Furthermore, the object 4 and detection device D shown in FIG. 4 are placed on the same surface. However, the object 4 and the detection device D may also be placed on two separate surfaces. These separate surfaces may be located at different heights or positions.

In some embodiments, the detection device D may comprise a non-destructive testing tool, including but not limited to the following equipment: atomic force microscope (AFM), transmission electron microscope (TEM), focused ion beam microscope (FIB), scanning probe microscopy (SPM), electrostatic force microscopy (EFM), scanning capacitance microscopy (SCM), and scanning ion conductance microscope (SICM).

The above embodiments merely describe the principle and effects of the present disclosure, instead of being used to limit the present disclosure. Therefore, persons skilled in the art can make modifications to and variations of the above embodiments without departing from the spirit of the present disclosure. The scope of the present disclosure should be defined by the appended claims.

What is claimed is:

1. A manipulator for clamping a probe, comprising:
a positioning adjustment assembly arranged on a positioning adjustment base, the positioning adjustment assembly comprising:
a first slide rail assembly located in the positioning adjustment assembly, the first slide rail assembly comprising:
a first slide rail cover, which comprises a first slide groove configured to receive a first slide rail of a first slide rail base, wherein the first slide rail is slidable along a first direction relative to the first slide groove; and
a first elastic element, with two ends attached to the first slide rail base and the first slide rail cover, respectively;
a first handwheel assembly, which comprises a first shaft portion configured to contact the first slide rail cover;
a cantilever, with one end connecting to the positioning adjustment assembly, the cantilever comprising a groove configured to receive a connecting member; and
a clamping member comprising a hole, wherein a first end of the clamping member is configured to connect with the connecting member.

2. The manipulator of claim 1, wherein a first handwheel bracket is arranged on the first slide rail base, the first handwheel bracket comprising a first guiding member, and the first shaft portion of the first handwheel assembly is configured to engage with a through hole of the first guiding member.

3. The manipulator of claim 1, wherein the positioning adjustment assembly further comprises:
a second slide rail assembly, which comprises:
a second slide rail connecting plate connected to the first slide rail assembly;
a second slide rail cover, which comprises a second slide groove configured to receive a second slide rail of a second slide rail base, wherein the second slide rail is slidable along a second direction relative to the second slide groove; and
a second elastic element, with two ends attached to the second slide rail base and the second slide rail cover, respectively; and
wherein the manipulator further comprises a second handwheel assembly, which comprises a second shaft portion configured to contact the second slide rail cover, and wherein the second direction is substantially perpendicular to the first direction.

4. The manipulator of claim 3, wherein a second handwheel bracket is arranged on the second slide rail base, the second handwheel bracket comprising a second guiding member, and the second shaft portion of the second handwheel assembly is configured to engage with a through hole of the second guiding member.

5. The manipulator of claim 3, wherein the positioning adjustment assembly further comprises:
a third slide rail assembly, which comprises:
a third slide rail connecting plate connected to the second slide rail assembly;
a third slide rail cover, which comprises a third slide groove configured to receive a third slide rail of a third slide rail base, wherein the third slide rail is slidable along a third direction relative to the third slide groove; and
a third elastic element, with two ends attached to the third slide rail base and the third slide rail cover, respectively; and
wherein the manipulator further comprises a third handwheel assembly, which comprises a third shaft portion configured to contact the third slide rail cover, and wherein the third direction is substantially perpendicular to the first direction and the second direction.

6. The manipulator of claim 5, wherein a third handwheel bracket is arranged on the third slide rail base, the third handwheel bracket comprising a third guiding member, and the third shaft portion of the third handwheel assembly is configured to engage with a through hole of the third guiding member.

7. The manipulator of claim 1, wherein the first slide rail cover is configured to move ±10 mm relative to the first slide rail base along the first direction.

8. The manipulator of claim 1, wherein the cantilever further comprises a cantilever connecting plate, and the one end of the cantilever is connected to the positioning adjustment assembly through the cantilever connecting plate.

9. The manipulator of claim 1, wherein a first end of the connecting member is located within the groove of the cantilever and is pivotally connected to the cantilever, so that the connecting member is configured to rotate relative to the cantilever about the first end in a first plane formed by a first direction and a second direction.

10. The manipulator of claim 9, wherein the connecting member is configured to rotate in the first plane approximately 10 degrees.

11. The manipulator of claim 9, wherein the cantilever further comprises a height adjustment knob arranged adjacent to a second end opposite to the first end of the connecting member.

12. The manipulator of claim 11, wherein the manipulator further comprises an elastic element arranged between the cantilever and the clamping member, two ends of the clamping element being fixed to a first anchor member of the cantilever and a second anchor member of the clamping member, respectively.

13. The manipulator of claim 12, wherein the second anchor member is arranged on a protrusion of the clamping member.

14. The manipulator of claim 1, wherein the first end of the clamping member is pivotally connected to a second end opposite to the first end of the connecting member, so that the clamping member is configured to rotate relative to the cantilever about the second end of the connecting member in a second plane formed by a second direction and a third direction.

15. The manipulator of claim 14, wherein the clamping member is configured to rotate in the second plane approximately 70 degrees.

16. The manipulator of claim 1, wherein the hole of the clamping member is formed between a first positioning plate and a second positioning plate, and one or more distance adjustment elements are arranged between the first positioning plate and the second positioning plate.

17. The manipulator of claim 1, wherein the manipulator further comprises a cable clip arranged on the positioning adjustment assembly.

18. The manipulator of claim 1, wherein the positioning adjustment base comprises a magnetic material.

19. A detection device for detecting a physical feature of a micro-nano component, comprising:
a manipulator of any one of claim 1;
a probe holder accommodated within the hole of the clamping member;
at least one probe, which engages one end of the probe holder.

20. A method for detecting a physical feature of a micro-nano component, comprising:
arranging a detection device of claim 19 on a base surface;
providing a light source to irradiate the surface of the micro-nano component, so as to obtain an optical signal; and
receiving and processing the optical signal to obtain information related to the physical feature of the micro-nano component.
